(19) United States
(12) Patent Application Publication
(10) Pub. No.: US 2006/0285563 A1
(43) Pub. Date: Dec. 21, 2006

(54) Optical apparatus

(75) Inventor: Katsuhiko Hakomori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/280,341

(22) Filed: Nov. 17, 2005

(30) Foreign Application Priority Data
Jun. 21, 2005 (JP) 2005-180808

(51) Int. Cl. H01S 3/04; H01S 3/00

(52) U.S. Cl. 372/38.01; 372/38.07; 372/34

(57) ABSTRACT

The present invention is an optical apparatus which enables highly accurate detection of the LD ambient temperature by means of a simple constitution. The apparatus of the present invention therefore comprises a laser diode for emitting output light; a photodiode disposed in proximity to the laser diode; a forward bias supplier for supplying forward bias voltage to the photodiode when the laser diode is not emitting the output signal light; and an ambient temperature detection unit for detecting ambient temperature of the laser diode based on a terminal voltage of the photodiode to which the forward bias voltage is supplied by the forward bias supplier.

### BACKGROUND OF THE INVENTION

1) Field of the Invention

The present invention relates to optical apparatuses, and particularly to apparatuses which are suitably used in subscriber devices in a GE-PON (Gigabit Ethernet-Passive Optical Network).

2) Background of the Invention

With the rapid spread of IP and Internet, implementation of large-capacity communication, referred to as broadband, for subscribers using optical fiber has been enabled, thereby realizing high-level transmission services such as interactive communication with media, and video-on-demand. Particularly, recent enhancement of transmission rate is remarkable, wherein GE-PON, currently the focus of attention, is a high-speed optical subscriber transmission system which has achieved a downstream signal transmission rate of 1.25 Gb/s.

FIG. 7 illustrates a general PON optical subscriber transmission system 500, wherein an OLT (Optical Line Terminal) 501 as the station side device and a plurality of ONUs (Optical Network Unit) 511 to 51n as the subscriber side devices are connected via optical fiber 502 and an optical star coupler 503. The optical star coupler 503 branches the signal light from the OLT 501, distributes the branched light to each of the ONUs 511 to 51n, and supplies the signal light from the ONUs 511 to 51n to the OLT 501.

In addition, transmission cycle of the signal light from the ONUs 511 to 51n to the OLT 501 is determined so as to avoid collision between signal lights from the ONUs 511 to 51n to the OLT 501, by performing management in accordance with a best-effort system at the OLT 501. Specifically, in the OLT 501, time-division time slots #1 to #n result in assignment as transmission cycles to each of the ONUs 511 to 51n, as shown in FIG. 8.

In the case that the above-mentioned transmission system 500 is constituted according to the GE-PON standard IEEE 8-2.3ah, a 1.3 μm band burst signal provided by the above-mentioned time-division is used as the upstream digital signal from the ONUs 511 to 51n. On the other hand, a continuous signal of 1.49 μm band (1.48 to 1.50 μm) is used as the downstream digital signal from the OLT 501, wherein the continuous signal is uniformly transmitted to each the ONUs 511 to 51n.

FIG. 9 is a diagram showing an optical transceiver 520 used as the ONUs 511 to 51n. The optical transceiver 520 shown in FIG. 9 comprises an optical unit 530, a light transmitting circuit 540, and a light receiving circuit 550. The optical unit 530 comprises an LD (Laser Diode) module 531, a half mirror 532, an optical filter 533, and a photodiode 534.

The LD module 531 is constituted by packaging, as a single module, the LD 531a which is driven by an electric signal from a light transmitting circuit 540 to emit signal light, and a monitor PD (Photo Diode) 531b which is disposed in a location making it possible to receive backward light of the light emitted by the LD 531a.

A half mirror 532 is constituted so as to let the signal light of 1.3 μm band emitted by the LD 531a pass through and guide it as transmission signal light to the optical fiber 560 (502, in the case of FIG. 7), while reflecting the received signal light of 1.49 μm band from an optical fiber 560 (signal light from the OLT 501, in the case of FIG. 7) and guiding it to the optical filter 533. And then the optical filter 533 is constituted to let the light in the 1.49 μm band of the received signal light wavelength among the incident light from the half mirror 532 pass through, and be received by the photodiode 534. In addition, the received signal light which is received by the photodiode 534 is converted into an electric signal by the light receiving circuit 550 to be output as a received data.

The light transmitting circuit 540 is constituted to input therein the transmission data to be modulated into a light which emits in the LD 531a, and the light transmitting circuit 540 drives the LD 531a with an electric signal (current signal) based on the transmission data. At this time, the static characteristic of the LD 531a is known to have a characteristic such that the threshold current Ith varies according to ambient temperature (driving current vs. optical output characteristic), as shown in FIG. 10, for example.

In the case that the bias voltage is smaller than a threshold voltage Ith of the temperature, emission delay time DT results in generation in the optical output from the LD 531a against input pulse P comprising the transmission data, as shown in FIG. 11. Therefore it becomes necessary for the LD 531a to supply Ith as bias current in accordance with the temperature (current value being the starting point of light emission in accordance with the temperature shown in FIG. 10), in order to reduce the light emission delay time DT when modulating the transmission data, as shown in FIG. 12.

Accordingly, accurate information of the LD ambient temperature as the control condition of driving current is necessary to suppress the light emission delay time when outputting the signal light while driving the LD 531a. In the conventional optical transceiver 520, a temperature sensor such as a thermistor (not shown) for detecting ambient temperature is provided for the light transmitting circuit 540 so as to determine the bias current to be supplied to the LD 531a based on the result of temperature detection by the thermistor.

In addition, the following patent document 1 and non-patent document 1 disclose a known technique relating to the present invention.

In the technique described in the patent document 1, a table is prepared beforehand with regard to temperature information corresponding to the difference of dark current between the cases of not applying bias voltage to the photodiode and applying bias voltage of the reverse voltage, and temperature information is then retrieved from the above-mentioned difference of dark current by referring to the table.

The non-patent document 1 describes a technique to perform APC control (Automatic Power Control) over the LD output in the OLT using monitor PD, along with the transmission system with regard to the above-mentioned GE-PON.

(Patent Document 1) Japanese Patent Application Laid-open No. 2001-216672.

(Non-Patent Document 1) Technical Report of the IEICE Japan _OCS2004-75_{—}0FT2004-38

With the optical transceiver 500 shown in FIG. 9, sensitivity is relatively low concerning the detection precision of the LD ambient temperature, because a temperature sensor such as a thermistor is mounted on the light transmitting circuit 540 separated from the LD 531a. Particularly, the difference between the actual LD ambient temperature and the temperature detected by the thermistor mounted on the light transmitting circuit 540 increases as the distance between the LD 531a and the temperature sensor becomes larger, as shown in FIGS. 13, 14, for example.

However, it is empirically known that such temperature difference is equalized over time after makeup of a power supply. Specifically, as shown in FIG. 15, for example, a relatively long stand-by time (ten minutes and more) is required before the temperature within the optical unit 530 (see FIG. 9) stabilizes (the temperature detected by the temperature sensor mounted on the light transmitting circuit 540 becomes substantially equal to the LD ambient temperature), at the time a power supply of the optical transceiver 520 (see FIG. 9) is started. Consequently, a problem exists in that the adjustment time with regard to the instrument characteristic at manufacturing becomes longer than the actual operation time, until the temperature detected by the sensor stabilizes after providing power supply. It is thus needed to reduce such adjustment time at manufacturing, in order to improve manufacturing efficiency.

Additionally, with a conventional optical transceiver described above, there are some cases in which forced air cooling is performed in order to exhaust the heat generated by electricity consumption within the optical transceiver, thereby generating airflow inside the apparatus, so that the temperatures at the installed positions of both the temperature sensor and the LD are varied according to air volume and wind direction. As a result, there exists a problem in that control is difficult due to the error occurrence in the precision of detection by the temperature sensor.

Although, it is conceivable, in comparison to the above approach, that a dedicated temperature sensor may be built in proximity to the LD in the optical unit 530, instead of installing the temperature sensor on the light transmitting circuit 540 shown in FIG. 9, the sensor is very expensive since it is a highly-specific optical module, of which only a small quantity is produced. Hence, there also exists a problem in that it is difficult to use the module for an ONU optical transceiver of the optical subscriber requiring low-price.

In addition, although detection of the temperature is performed using dark current of the PD, in the technique described in the patent document 1, since the temperature characteristics of dark current of the PD is unstable and cannot be derived qualitatively, it is necessary to measure the temperature characteristics according to the difference of dark current as described in the patent document 1 finely beforehand, and temporal variation of the characteristic is envisioned.

### SUMMARY OF THE INVENTION

The present invention has been devised in view of the above problems, and an object of the present invention is to provide an optical apparatus with simple constitution which is capable of facilitating detection of the LD ambient temperature with high accuracy.

Accordingly, the optical apparatus of the present invention is characterized by comprising a laser diode for emitting output light; a photodiode disposed in proximity to the laser diode; a forward bias supplier for supplying forward bias voltage to the photodiode when the laser diode is not emitting the output light; and an ambient temperature detection unit for detecting ambient temperature of the laser diode based on a terminal voltage of the photodiode to which the forward bias voltage is supplied by the forward bias supplier.

Further, the optical apparatus of the present invention is characterized by comprising a laser diode for emitting output light; a photodiode disposed in proximity to the laser diode, at a location allowing reception of backward light of the output light; a PD bias supplier for supplying reverse bias voltage to the photodiode when the laser diode is emitting the output light, and supplying forward bias voltage to the photodiode when the laser diode is not emitting the output light; an ambient temperature detection unit for detecting ambient temperature of the laser diode based on a terminal voltage of the photodiode to which the forward bias voltage is supplied by the PD bias supplier when the laser diode is not emitting the output light; a monitor for monitoring the output light from the laser diode, based on an electric signal from the photodiode to which reverse bias voltage is supplied by the PD bias supplier when the laser diode is emitting the output light.

In this case, preferably, the PD bias supplier may be constituted by comprising a forward bias supplier for supplying forward bias voltage to the photodiode; a reverse bias supplier for supplying reverse bias voltage to the photodiode; and a switch unit for switching the conductivity of the forward and reverse bias suppliers to the photodiode between conduction and insulation, in order to supply reverse bias voltage to the photodiode by the reverse bias supplier when the laser diode is emitting light, and supply forward bias voltage to the photodiode by the forward bias supplier when the laser diode is not emitting light.

Furthermore, the apparatus may be constituted such that the reverse bias supplier and the forward bias supplier are disposed with the photodiode located therebetween and constituted such that supply voltage of the reverse bias supplier becomes larger than supply voltage of the forward bias supplier, while the switch unit comprises a first switch disposed between the reverse bias supplier and the photodiode, for switching on and off the supply of the reverse voltage to the photodiode by the reverse bias supplier; and a second switch for switching on and off the supply of the forward voltage to the photodiode by the forward bias supplier, wherein the first switch is switched on and the second switch is switched off when the laser diode is emitting light, whereas the first switch is switched off and the second switch is switched on when the laser diode is not emitting light.

In addition, the PD bias supplier may also be constituted such that a transmission control signal is input therein from outside for controlling the timing and the time period which allows emission and output of the output light, so as to result in operation, based on the transmission control signal, in an emitting mode of the output light when being at a timing and in a time period which allows emission and output of the output light, or in a non-emitting mode of the output light when not being at a timing and in a time period which allows emission and output of the output light.

Further, an LD bias current controller may be provided for variably controlling bias current supplied to the laser diode, based on ambient temperature of the laser diode detected by the ambient temperature detection unit. In this case, an alarm dispatcher may be provided for outputting an alarm signal when resulting in occurrence of failure in light emission of the laser diode, based on results of monitoring by the monitor.

Furthermore, the above-mentioned optical apparatus may be constituted as a subscriber side unit in a Gigabit Ethernet Passive Optical Network.

As thus described, the present invention is advantageous in that, by providing an ambient temperature detection unit, detection of ambient temperature of the laser diode with a high accuracy is possible, by means of a simple constitution in which a photodiode for monitoring purpose, packaged within a conventional light emitting module, may be used for detecting the temperature, without providing a dedicated temperature sensor in the same package as the laser diode.

### BRIEF DESCRIPTION OF THE DRAWINGS

FIG. 1 is a view showing an optical apparatus according to an embodiment of the present invention;

FIG. 2 is a view showing the main part of the optical apparatus in the present embodiment;

FIG. 3 is a view showing the main part of the optical apparatus in the present embodiment;

FIG. 4 is a view illustrating the temperature characteristics of voltage at both terminals of the PD under a condition in which the forward bias voltage is applied;

FIG. 5 is a view illustrating the temperature characteristics of voltage at both terminals of the PD under a condition in which the forward bias voltage is applied;

FIG. 6 is a view illustrating the operation of the optical apparatus in the present embodiment;

FIG. 7 is a view showing a general PON optical subscriber transmission system;

FIG. 8 is a view illustrating an aspect of signal transmission from the ONU to the OLT in the PON optical subscriber transmission system shown in FIG. 7;

FIG. 9 is a view showing an optical transceiver used as the ONU;

FIG. 10 is a view showing the characteristics of driving current vs. optical output of the LD;

FIG. 11 is a view illustrating the light emission delay time;

FIG. 12 is a view showing the bias current according to the temperature for reducing the light emission delay time;

FIG. 13 is a view illustrating that the difference between the actual ambient temperature of the LD and the temperature detected by the temperature sensor becomes larger as the distance between them becomes farther;

FIG. 14 is a view illustrating that the difference between the actual ambient temperature of the LD and the temperature detected by the temperature sensor becomes larger as the distance between them becomes larger; and

FIG. 15 is a view illustrating the time period before the detection temperature of the thermistor provided in a module which is different from the LD stabilizes.

### DESCRIPTION OF THE PREFERRED EMBODIMENTS

Embodiments of the present invention will be described below with reference to the drawings. Here, in addition to the above-mentioned objects of the present invention, other technical problems, methods and their effects of operation for solving the technical problems will be clarified by disclosing the embodiments as follows.

### [A] Description of an Embodiment of the Present Invention

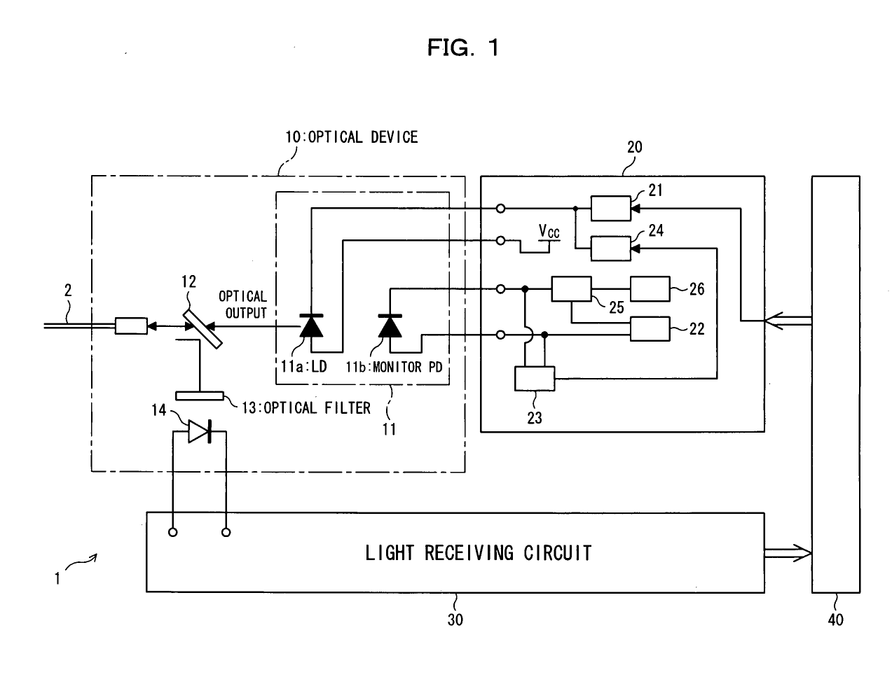

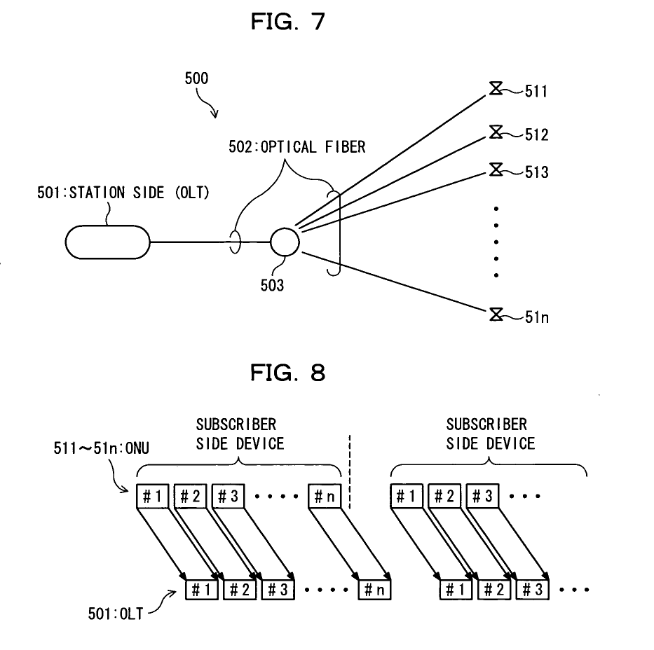

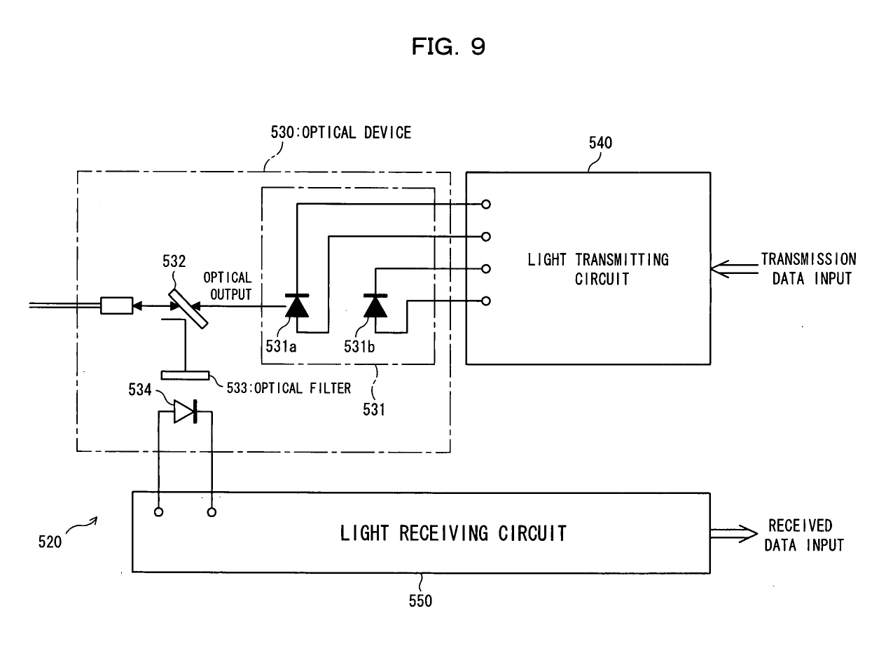

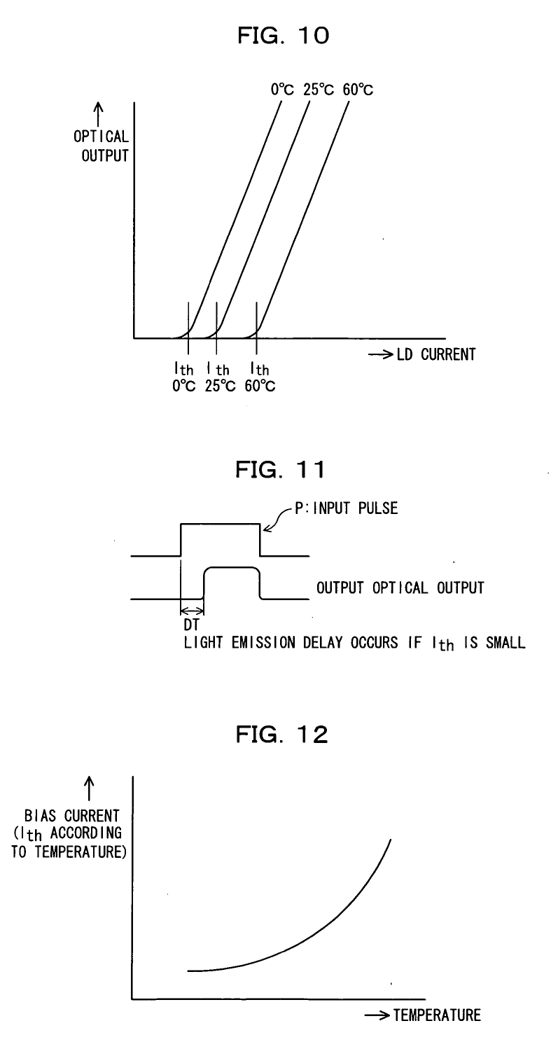

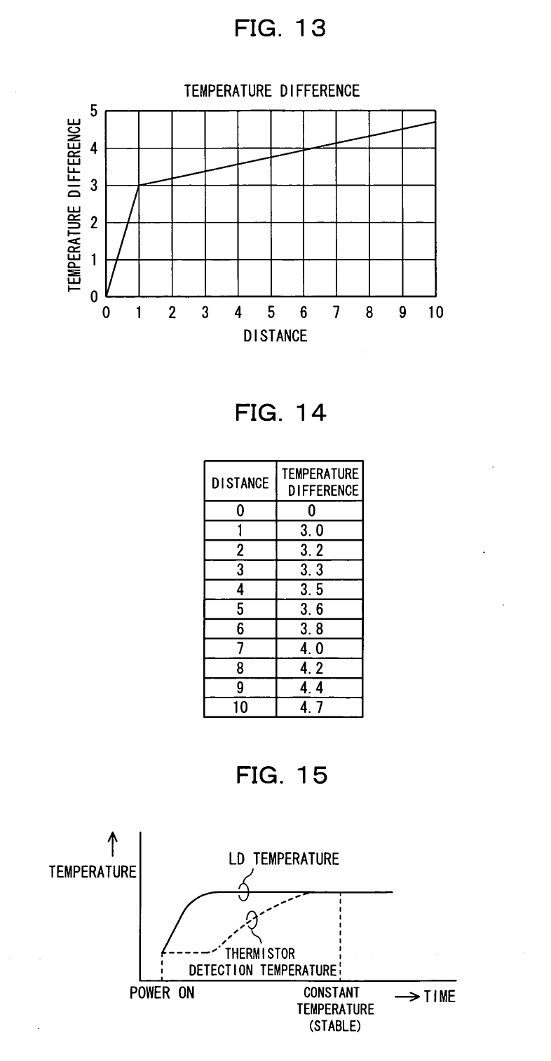

FIG. 1 is a view showing an optical communication apparatus 1 according to an embodiment of the present invention. The optical communication apparatus 1, like the optical transceiver 520 shown in FIG. 9, may be capable of being constituted as an ONU in the transmission system (see FIG. 7) of GE-PON. The optical communication apparatus 1 comprises an optical device unit 10, a light transmitting circuit 20, a light receiving circuit 30, and a signal processing circuit 40. The optical device unit 10 and the light receiving circuit 30 have a substantially similar constitution with those shown in the above-mentioned FIG. 9 (see elements numbered 530 and 550).

That is, the optical device unit 10 comprises, like the optical device unit 530 shown in FIG. 9, an LD module 11 which is composed of an LD 11a and a monitor PD 11b, a half mirror 12, an optical filter 13, and a photodiode 14. In addition, a signal processing circuit 40 supplies transmission data which should be emitted as signal light to the light transmitting circuit 20, receives the signal light which has been transmitted through the optical fiber 2 and converted into received data by the light receiving circuit 30, and processes the received signal.

In addition, although the light transmitting circuit 20 drives LD 11a in order to output the signal light which is the modulated transmission data from the signal processing circuit 40, it also has a functionality of detecting ambient temperature of the LD 11a based on the terminal voltage of the PD 11b provided in proximity to the LD 11a.

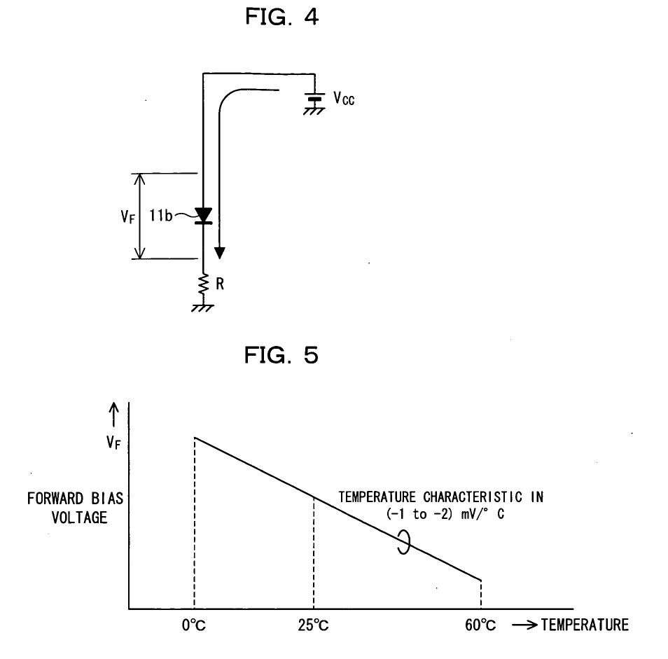

The PD 11b, including a PN junction structure, is characteristic in that electric current flows corresponding to the quantity of light received under the condition in which reverse bias voltage is being applied. On the other hand, under the condition in which forward bias voltage is applied, as shown in FIG. 4, the voltage VF at both terminals of the PD always has a constant negative temperature characteristic as shown in FIG. 5, for example. That is, there exists a relationship that, when the ambient temperature rises by 1° C., the terminal voltage VF falls by a constant voltage in the range of −1 to −2 mV.

The light transmitting circuit 20 further comprises a functionality of providing forward terminal voltage to the above-mentioned PD 11b, a functionality of detecting ambient temperature of the LD 11a based on the PD terminal voltage, using the above-mentioned characteristic of the PD terminal voltage relative to the temperature variation, and a functionality of supplying bias current to the LD 11a based on the detected ambient temperature. Accordingly, the light transmitting circuit 20 comprises a transmission data modulator 21, a PD bias supplier 22, an ambient temperature detection unit 23, and a LD bias current controller 24, as well as a monitor 25 and an alarm dispatcher 26.

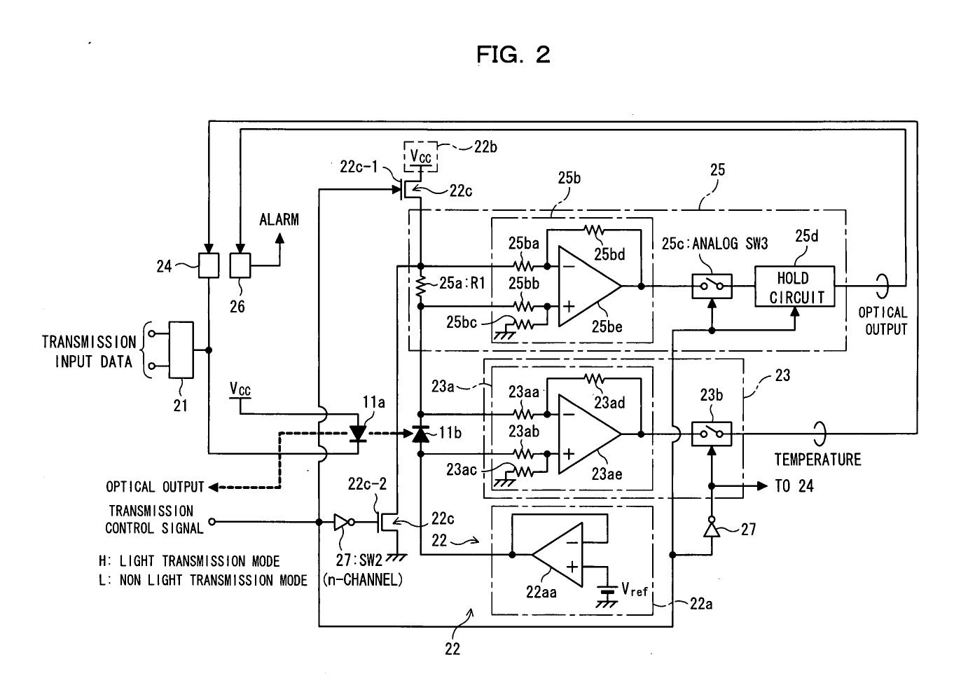

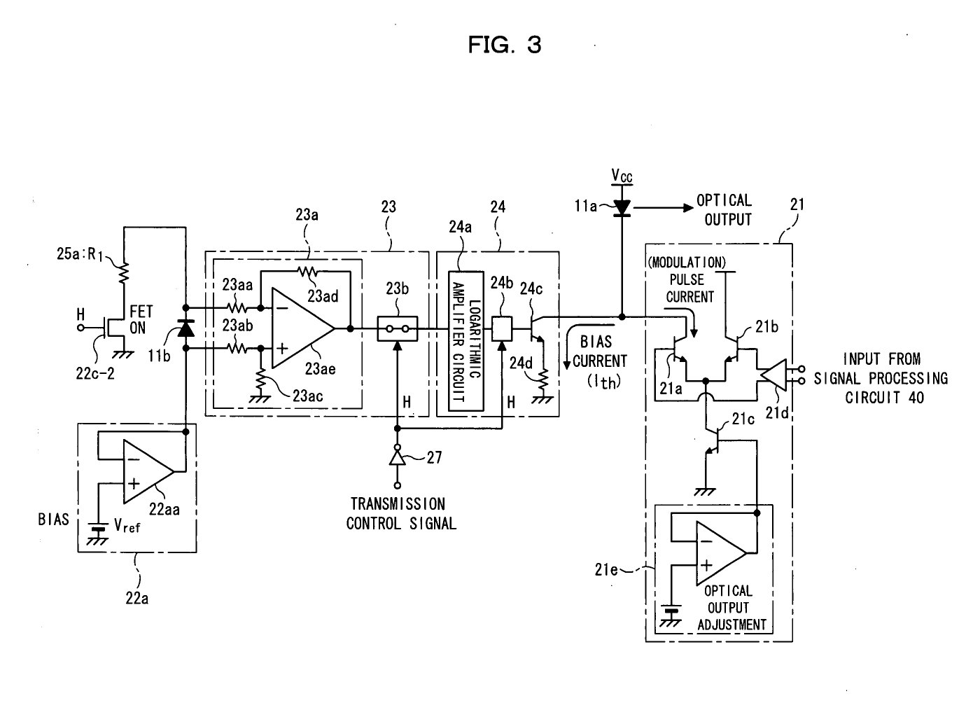

FIG. 2 is a view showing a constitution of the transmission data modulator 21, the PD bias supplier 22, the ambient temperature detection unit 23, the LD bias current controller 24, the monitor 25, and the alarm dispatcher 26 composing the light transmitting circuit 20, together with the LD 11a and the PD 11b. FIG. 3 is a view particularly showing, giving attention to, the constitution of the transmission data modulator 21, the ambient temperature detection unit 23, and the LD bias current controller 24.

The transmission data modulator 21 comprises, as shown in FIG. 3, transistors 21a to 21c, an amplifier 21d, and a voltage follower circuit 21e for light output adjustment, performing pulse modulation to the current flowing through the LD 11a, based on the transmission data from the signal processing circuit 40, wherein the light emitted from the LD 11a may be utilized as the transmission signal light to which pulse modulation has been performed, because the LD 11a is driven with the electric current which has been pulse-modulated by the transmission data modulator 21.

In addition, the PD bias supplier 22 is constituted by composing, as shown in FIG. 2, a forward bias supplier 22a, a reverse bias supplier 22b, and a first and a second switches 22c-1 and 22c-2.

Here, the forward bias supplier 22a supplies forward bias voltage to the photodiode 11b and comprises, in the present embodiment, a voltage follower circuit consisting of a constant voltage source Vref and an amplifier 22aa. In addition, the reverse bias supplier 22b supplies forward bias voltage Vcc to the photodiode 11b and comprises a voltage source Vcc for providing forward bias.

Furthermore, the above-mentioned the forward bias supplier 22a and the reverse bias supplier 22b are disposed with the photodiode located therebetween and constituted such that supply voltage of the reverse bias supplier becomes larger than supply voltage of the forward bias supplier.

In addition, a first switch 22c-1 performs ON/OFF switching with regard to supply of reverse bias voltage to the photodiode 11b by the reverse bias supplier 22b, according to a transmission control signal from the OLT (not shown). Furthermore, a second switch 22c-2 performs ON/OFF switching with regard to supply of forward voltage to the photodiode 11b by the forward bias supplier 22a, according to a transmission control signal from the OLT (not shown). The first and the second switches 22c-1 and 22c-2 are capable of being composed of MOSFET (Metal Oxide Semiconductor Field Effect Transistor), for example.

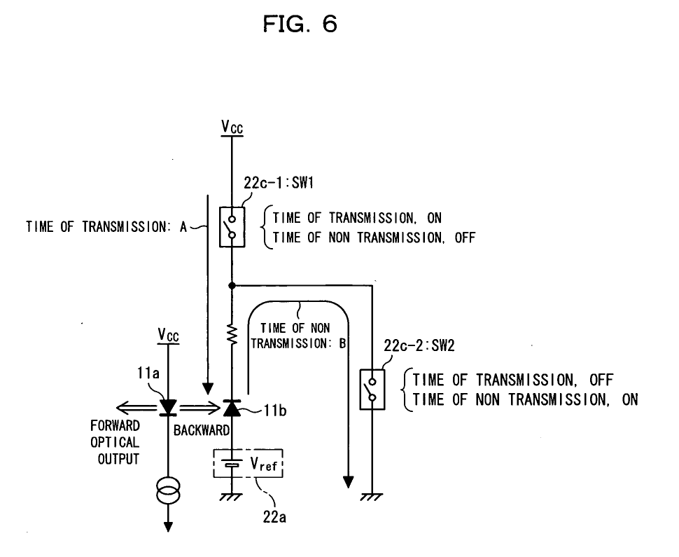

FIG. 6 is a view illustrating the bias voltage applied to the photodiode 11b by performing ON/OFF switching of the first and the second switches 22c-1 and 22c-2. In the present embodiment, the ON/OFF switching of the first and the second switches 22c-1 and 22c-2 is performed according to a control signal (transmission control signal) with regard to the transmission timing and the time period from the OLT (not shown).

That is, when receiving a transmission control signal from the OLT via the optical device unit 10 and the light receiving circuit 30, the signal processing circuit 40 outputs a control signal to the first and the second switches 22c-1 and 22c-2, in order to perform ON/OFF switching thereof, while being interlocked with the transmission timing and the non-transmission timing according to the above-mentioned transmission control signal.

Specifically, when the ONU is transmitting as the signal light, that is, when the laser diode 11a is emitting light according to the transmission control signal from the OLT, the first switch 22c-1 is switched on and the second switch 22c-2 is switched off by a control signal (high level signal) from the signal processing circuit 40. At this point, the reverse bias supplier 22b and the forward bias supplier 22a become conductive, and reverse bias voltage will be applied to the photodiode 11b as a consequence since the supplied voltage of the reverse bias supplier 22b is constituted to be larger than the supplied voltage of the forward bias supplier 22a, (see A of FIG. 6).

In addition, when the ONU is not transmitting signal light, that is, when the laser diode 11a is not emitting light, according to the transmission control signal from the OLT, forward bias voltage will be applied to the photodiode 11b (see B of FIG. 6), by making the first switch 22c-1 off and making the second switch 22c-2 on according to a control signal (low level signal) from the signal processing circuit 40.

In addition, in FIG. 2, element 27 is an inverter for inverting the control signal from the signal processing circuit 40, i.e. the transmission control signal from the OLT. That is, the control signals being input to the first switch 22c-1 and the second switch 22c-2 for switching their ON/OFF status are set to be mutually inverse. For example, when a control signal is being input to switch on the first switch 22c-1, a control signal for switching off the second switch 22c-2 will be input.

Accordingly, a switch unit 22c for switching the conductivity of the forward and reverse bias suppliers 22a and 22b to the photodiode 11b between conduction and insulation comprises the above-mentioned first switch 22c-1 and the second switch 22c-2, in order to supply reverse bias voltage to the photodiode 11b by the reverse bias supplier 22b when the laser diode 11a is emitting light, and supply forward bias voltage to the photodiode 11b by the forward bias supplier 22a when the laser diode 11a is not emitting light.

In addition, the ambient temperature detection unit 23 shown in FIG. 1 detects the ambient temperature of the laser diode 11a based on the terminal voltage of photodiode 11b to which forward bias voltage is supplied by the forward bias supplier 22a and comprises, as shown in FIG. 2, a voltage conversion circuit 23a and an analog switch 23b.

The voltage conversion circuit 23a outputs the terminal voltage of photodiode 11b to the analog switch 23b as a one-output electric signal and comprises resistors 23aa to 23ad and an amplifier 23a e. Furthermore, the analog switch 23b is input therein, from the inverter 27, an ON/OFF control signal which is similar to the ON/OFF control signal provided to the second switch 22c-2, and performs switching between OFF when the transmission control signal from the OLT indicates an “emitting mode” and ON when the transmission control signal from the OLT indicates a “non-emitting mode”.

In other words, since the value of the electric signal being output from the analog switch 23b during its ON status (“non-emitting mode”) is the “terminal voltage information according to the ambient temperature” in the above-mentioned characteristic shown in FIG. 5, the electric signal value can be uniquely used as the detected information of the “ambient temperature”.

In addition, although the terminal voltage of the PD 11b to which forward bias voltage is applied has a characteristic which depends on the ambient temperature of the PD 11b as described above, the LD 11a is accommodated within the same package as the PD 11b, and in proximity to the LD 11a, whereby the ambient temperature of the LD 11a can also be detected accurately based on the detected information of the PD 11b ambient temperature.

In addition, the LD bias current controller 24 variably controls the bias current to be supplied to the laser diode 11a, based on the ambient temperature of the laser diode 11a detected in the ambient temperature detection unit 23, and comprises, as shown in FIG. 3, a logarithm amplifying circuit 24a, a hold circuit 24b, a transistor 24c and a resistor 24d.

Additionally, the logarithmic amplifying circuit 24a converts the terminal voltage signal which is output via the ON-controlled analog switch 23b, into a signal having bias current value information which should be set in accordance with the ambient temperature of the PD 11b (which is equivalent to the ambient temperature of the LD 11a). That is, the terminal voltage of PD 11b (see FIG. 5) will be converted to an electric signal having the above-mentioned bias current value information as shown in FIG. 12. The logarithmic amplifying circuit 24a can raise the precision of setting the LD bias current corresponding to the detected LD ambient temperature.

Furthermore, the hold circuit 24b holds the output value from the logarithm amplifying circuit 24a when the above-mentioned analog switch 23b is switched ON. That is, when the transmission control signal from the OLT indicates a “non-emitting mode”, the bias current setting information according to the ambient temperature input from the logarithmic amplifying circuit 24a is held. That is, in the hold circuit 24b, even if the transmission control signal from the OLT is switched from “non-emitting mode” to “emitting mode” thereby letting reverse bias voltage be supplied to the PD 11b, the LD bias current setting information which has been obtained based on the PD terminal voltage when the preceding forward bias voltage has been supplied will be retained unchanged.

In addition, the LD ambient temperature is not detected during the time period in which the transmission control signal from the OLT is in “emitting mode”, and the bias current according to the temperature detected immediately before in the “non-emitting mode” is supplied to the LD 11a. During the time period in which the transmission control signal from the OLT is in “emitting mode”, the necessity is relatively low to envision a temperature variation such that control is required of the bias current during the time period, because the period corresponds to a time slot assigned to the ONU of the time division multiplexing.

Furthermore, the transistor 24c shown in FIG. 3 provides bias current to the LD 11a based on the bias current setting information which is held in the hold circuit 24b along with the resistor 24d. Thus the bias current provided for the LD 11a can be set to an appropriate value, as shown in FIG. 12, in accordance with the LD ambient temperature detected by the PD 11b to which forward bias voltage is applied.

Furthermore, the monitor 25 monitors the transmission signal light from the laser diode 11a based on the electric signal from the photodiode 11b to which reverse bias voltage is supplied by the PD bias supplier 22, when the transmission signal light is being emitted from the laser diode 11a, and comprises a voltage conversion circuit 25b, an analog switch 25c and a hold circuit 25d, as well as a resistor 25a for taking out current flowing through the PD 11b.

That is, with the transmission control signal switched on (high-level), consequently switching on the first switch 22c-1 and switching off the second switch 22c-2, the reverse bias supplier 22b becomes conductive with the PD 11b via the resistor 252. At this point, although the forward bias supplier 22a supplies counter electromotive force to the reverse bias supplier 22b, reverse bias will be consequently applied to the PD 11b because of the arrangement such that the supply voltage of the reverse bias voltage supplier 22b becomes larger than the supply voltage of the forward bias voltage supplier 22a (Vcc>Vref).

The monitor 25 is constituted such that, under a condition wherein such reverse bias is being applied to the PD 11b, the transmission signal light emitted from the LD 11a can be monitored upon obtaining, from the terminal voltage of the resistor 25a, the electric current value flowing through the PD 11b which varies according to the power of received light emitted by the LD 11a.

Here, the voltage conversion circuit 25b outputting the terminal voltage of the resistor 25a to the analog switch 25c as a one-output electric signal comprises resistors 25ba to 25bd and an amplifier 25be. Furthermore, the analog switch 25b receives input of an ON/OFF control signal which is similar to the one provided to the first switch 22c-1, and performs switching between ON when the transmission control signal from the OLT indicates an “emitting mode” and OFF when the transmission control signal from the OLT indicates a “non-emitting mode”.

That is, since the value of the voltage signal which is output from the analog switch 25c when it is controlled to be ON (“emitting mode”) is a voltage signal depending on the current value which varies in accordance with the emission of the LD 11a, the electric signal value can be uniquely used as the monitor information of the transmission signal light from the LD 11a.

Furthermore, the hold circuit 25d holds the output value when the above-mentioned analog switch 25c is switched ON. That is, monitor information of the transmission signal light from the LD 11a is retained when the transmission control signal from the OLT indicates an “emitting mode”. That is, in the hold circuit 25d, even if the transmission control signal from the OLT is switched from “emitting mode” to “non-emitting mode” thereby letting forward bias voltage be supplied to the PD 11b, the monitor information when the preceding forward bias voltage has being supplied will be retained unchanged.

In addition, the monitor 25 can output the mean value of the transmission signal light which is modulated with the transmission data as the monitoring result.

The alarm dispatcher 26 outputs an alarm signal when failure occurs in the emission at the laser diode 11a, based on the monitoring result by the monitor 25, wherein, for example, the output level from the monitor 25 is compared with a reference value which is becomes the criterion when determining whether or not failure has occurred in the emission, and if the output level from the monitor 25 is lower than the reference value, outputs an alarm notifying the occurrence of failure in the emission.

According to the constitution as described above, the ONU composing the optical communication apparatus 1 relating to one embodiment of the present invention outputs, from the LD 11a, transmission signal light which is the modulated transmission data from the signal processing circuit 40, at a transmission timing of the ONU itself, driven by the LD 11a in the light transmitting circuit 20, based on the transmission control signal from the OLT.

At this point, the PD bias supplier 22 switches the bias voltage applied to the PD 11b by controlling the ON/OFF status of the first and the second switches 22c-1 and 22c-2 based on the transmission control signal from the OLT. That is, the ONU causes the PD bias supplier 22 to apply reverse bias voltage at its own transmission timing (when the LD 11a is in emitting mode) thereby enabling the monitor 25 to monitor the emitting state of LD 11a, and applies forward bias voltage at a non-transmission timing (when the LD 11a is in non-emitting mode) thereby enabling the ambient temperature detection unit 23 to detect the ambient temperature of the LD 11a.

Thus, at a transmission timing of the ONU itself, the monitor 25 monitors the emitting state of the LD 11a, whereas, during a time period in addition to the transmission timing, the PD bias supplier 22 performs switching so that forward bias voltage is supplied to the PD 11b disposed behind the LD 11a, thereby causing the ambient temperature detection unit 23 to detect the ambient temperature of the LD 11a based on the terminal voltage of the PD 11b at this point.

Then, the LD bias current controller 24 controls the setting of the bias current value applied to the LD 11a, based on the ambient temperature of the LD 11a detected by the ambient temperature detection unit 23. At this point, emission delay time can be reduced compared with the conventional technique also in the case when a transmission timing of the ONU itself arrived, because the hold circuit 24b can hold the bias current unchanged whose setting is controlled in the bias current controller 24 thereby retaining an appropriate setting of the bias current of the LD 11a according to the ambient temperature.

As thus described, according to one embodiment of the present invention, it is advantageous in that, by providing an ambient temperature detection unit 23, detection of ambient temperature of the LD 11a with a high accuracy is possible, by means of a simple constitution in which the PD 11b packaged within a conventional light emitting module may be used for detecting the temperature, without providing a dedicated temperature sensor in the same package as the LD 11a.

In addition, compared with a conventional case in which a temperature sensor such as a thermistor is used at a location distant from the LD 11a, there is an advantage in that instantaneous and highly accurate temperature measurement is possible at the power-on timing, without temperature errors under any condition such as forced air cooling, thereby reducing adjustment time in manufacturing resulting in improved work efficiency in manufacturing.

Furthermore, in comparison with temperature detection using dark current of the PD, there is also an advantage in that detected temperature can be more stably measured without inter-individual differences than the case using the temperature characteristic of dark current of the PD, owing to the use of temperature dependency of the terminal voltage when forward bias voltage is applied.

### [B] Other Embodiments

Despite the above-mentioned embodiments, various kinds of modifications can be made and implemented without departing from the scope of the present invention.

For example, in a case wherein the emitting state of the LD 11a may be monitored by another device and the PD 11b need not be used to monitor the emitting state of the LD 11a, the above-mentioned functionalities such as switching the bias voltage applied to the PD 11b (the first and the second switches 22c-1 and 22c-2), applying reverse bias voltage (the reverse bias supplier 22b), and further functionalities as the monitor 25 and the alarm dispatcher 26 may be omitted.

Additionally, although the transmission control signal is supposed to be input from the OLT in the present embodiment, which is not meant to limit the present invention, it may be input from other than the OLT.

Besides, disclosure of the above-mentioned embodiment may facilitate manufacturing of apparatus of the present invention.

What is claimed is:

1. An optical apparatus comprising:
a laser diode for emitting output light;
a photodiode disposed in proximity to said laser diode;
a forward bias supplier for supplying forward bias voltage to said photodiode when said laser diode is not emitting said output light; and
an ambient temperature detection unit for detecting ambient temperature of said laser diode based on a terminal voltage of said photodiode to which the forward bias voltage is supplied by said forward bias supplier.

2. An optical apparatus comprising:
a laser diode for emitting output light;
a photodiode disposed in proximity to said laser diode, at a location allowing reception of backward light of said ouput light;
a PD bias supplier for supplying reverse bias voltage to said photodiode when said laser diode is emitting said ouput light, and supplying forward bias voltage to said photodiode when said laser diode is not emitting said ouput light;
an ambient temperature detection unit for detecting ambient temperature of said laser diode based on a terminal voltage of said photodiode to which forward bias voltage is supplied by said PD bias supplier when said laser diode is not emitting said ouput light;
a monitor for monitoring said ouput light from said laser diode, based on an electric signal from said photodiode to which reverse bias voltage is supplied by said PD bias supplier when said laser diode is emitting said ouput light.

3. The optical apparatus according to claim 2, wherein said PD bias supplier comprises:
a forward bias supplier for supplying forward bias voltage to said photodiode;
a reverse bias supplier for supplying reverse bias voltage to said photodiode; and
a switch unit for switching the conductivity of said forward and reverse bias suppliers to said photodiode between conduction and insulation, in order to supply reverse bias voltage to said photodiode by said reverse bias supplier when said laser diode is emitting light, and supply forward bias voltage to said photodiode by said forward bias supplier when said laser diode is not emitting light.

4. The optical apparatus according to claim 3, wherein said reverse bias supplier and said forward bias supplier are disposed with said photodiode located therebetween and configured such that supply voltage of said reverse bias supplier becomes larger than supply voltage of said forward bias supplier, while
said switch unit comprises:
a first switch disposed between said reverse bias supplier and said photodiode, for switching on and off the supply of said reverse voltage to said photodiode by said reverse bias supplier; and
a second switch for switching on and off the supply of said forward voltage to said photodiode by said forward bias supplier, wherein
said first switch is switched on and said second switch is switched off when said laser diode is emitting light, whereas said first switch is switched off and said second switch is switched on when said laser diode is not emitting light.

5. The optical apparatus according to claim 2, wherein a transmission control signal is input from outside for controlling the timing and the time period which allows emission and output of said ouput light, and said PD bias supplier is configured to operate, based on said transmission control signal, in an emitting mode of said ouput light when being at a timing and in a time period which allows emission and output of said ouput light, or in a non-emitting mode of said ouput light when not being at a timing and in a time period which allows emission and output of said ouput light.

6. The optical apparatus according to claim 1, further comprising an LD bias current controller for variably controlling bias current supplied to said laser diode, based on ambient temperature of said laser diode detected by said ambient temperature detection unit.

7. The optical apparatus according to claim 2, further comprising an LD bias current controller for variably controlling bias current supplied to said laser diode, based on ambient temperature of said laser diode detected by said ambient temperature detection unit.

8. The optical apparatus according to claim 6, further comprising an alarm dispatcher for outputting an alarm signal when failure occurs in light emission of said laser diode, based on results of monitoring by said monitor.

9. The optical apparatus according to claim 7, further comprising an alarm dispatcher for outputting an alarm signal when failure occurs in light emission of said laser diode, based on results of monitoring by said monitor.

10. The optical apparatus according to claim 1, arranged as a subscriber side device in a Gigabit Ethernet Passive Optical Network.

11. The optical apparatus according to claim 2, arranged as a subscriber side device in a Gigabit Ethernet Passive Optical Network.

12. The optical apparatus according to claim 3, arranged as a subscriber side device in a Gigabit Ethernet Passive Optical Network.

13. The optical apparatus according to claim 4, arranged as a subscriber side device in a Gigabit Ethernet Passive Optical Network.

14. The optical apparatus according to claim 5, arranged as a subscriber side device in a Gigabit Ethernet Passive Optical Network.

15. The optical apparatus according to claim 6, arranged as a subscriber side device in a Gigabit Ethernet Passive Optical Network.

16. The optical apparatus according to claim 7, arranged as a subscriber side device in a Gigabit Ethernet Passive Optical Network.

17. The optical apparatus according to claim 8, arranged as a subscriber side device in a Gigabit Ethernet Passive Optical Network.

18. The optical apparatus according to claim 9, arranged as a subscriber side device in a Gigabit Ethernet Passive Optical Network.
